(19) United States
(12) Patent Application Publication
(10) Pub. No.: US 2022/0200376 A1
(43) Pub. Date: Jun. 23, 2022

(54) ROTOR ASSEMBLY FOR A BRUSHLESS ELECTRIC MOTOR HAVING SINGLE-PIECE MAGNETIC FLUX CONDUCTORS

(71) Applicant: Nidec Corporation, Kyoto (JP)

(72) Inventor: Pascual GUARDIOLA, Ingersheim (DE)

(21) Appl. No.: 17/259,803

(22) PCT Filed: Jun. 25, 2019
(86) PCT No.: PCT/IB2019/055321

§ 371 Date: Jul. 28, 2021

(30) Foreign Application Priority Data
Jul. 13, 2018 (DE) 102018116987.6

(51) Int. Cl. H02K 1/276; H02K 15/03; H02K 21/14; H02K 1/28

(52) U.S. Cl. CPC H02K 1/276; H02K 1/28; H02K 21/14; H02K 15/03

(57) ABSTRACT

A rotor unit assembly of a brushless electric motor includes an annular rotor core surrounding a central axis permanent magnets around the rotor core in a circumferential direction of the rotor unit assembly and each including a planar outer contact surface, a planar inner contact surface, two axial end surfaces, and two side surfaces, and magnetic flux conductors. One magnetic flux conductor is respectively provided to one permanent magnet. The magnetic flux conductors each include a convex outer circumferential surface and a planar inner contact surface with the planar inner contact surfaces being in contact with the planar outer contact surfaces of thc corresponding permanent magnets. Each of the magnetic flux conductors is defined by a single unitary structure made of extruded material.

### CROSS REFERENCE TO RELATED APPLICATIONS

This is a U.S. national stage of PCT Application No. PCT/IB2019/055321, filed on Jun. 25, 2019, with priority under 35 U.S.C. §119(a) and 35 U.S.C. §365(b) being claimed from German Application No. 102018116987.6, filed Jul. 13, 2018; the entire disclosures of which are hereby incorporated herein by reference.

### 1. FIELD OF THE INVENTION

The present invention concerns a rotor assembly of a brushless electric motor and a brushless electric motor.

### 2. BACKGROUND

Prior art electric motors are known in which the rotor carries permanent magnets. The permanent magnets are arranged around a rotor core and sit on its outside. The rotor defines the geometrical axes and directions. A central axis coincides with the axis of symmetry of the rotor and also represents the axis of rotation of the rotor in the electric motor. The axial direction of the arrangement is in the direction of the axis of rotation. The radial direction is characterized by increasing distance from the central axis. The permanent magnets of the rotor are therefore on the outside in the radial direction. Tangential to the rotor is the circumferential direction, where each directional vector is perpendicular to a radius of the arrangement.

According to the prior art, the electric motor also has a stator arranged radially outside the rotor, which surrounds the rotor on the outside in a ring shape. The stator contains a number of electromagnets, which are generally formed by an iron core and a winding. A suitable current supply to the stator windings generates a rotating field, which in turn generates a torque in the rotor. The stator is located in a motor housing in which the rotor with its motor shaft is rotatably mounted.

The permanent magnets of the rotor are usually made of a brittle material. The magnets are not screwed to the rotor core, but sit on outwardly facing flat surfaces of the rotor core, where they are mechanically held by a magnet holder. The permanent magnets of the rotor are flat on the inside and lie in contact with the rotor. On the outside, the permanent magnets have a convex shape. The convexity has the advantage that the magnetic field towards the stator is focused on a small area in the circumferential direction and thus has a higher magnetic flux density there. Eddy current losses can thus be reduced.

DE 10 2006 056 882 A1 describes that the permanent magnets of the rotor are cuboidal and placed in pockets of a lamellar rotor core. The rotor core surrounds the magnets in it all around and is convexly shaped on the outside in the areas of the pockets. This has the advantage that the brittle magnets are easier to manufacture. In addition, eddy current losses between the magnets and the surrounding stator are reduced by the laminated core. However, the production of the rotor core with the pockets is relatively complex, which causes unwanted costs.

DE 10 2011 079 245 A1 reveals mounting pockets for permanent magnets, which are open on one side in radial direction, which opens the possibility to insert the magnets in radial direction from outside into the mounting pockets on the rotor core lamella package. On the side facing away from the receiving pocket, carriers of lamella segments are provided, which contribute to the reduction of eddy current losses.

### SUMMARY

Example preferred embodiments of the present disclosure provide rotor assemblies and electric motors in each which a rotor is particularly easy and inexpensive to manufacture.

A rotor assembly according to an example preferred embodiment of the present invention includes a brushless electric motor which includes an annular rotor core surrounding a central axis, a plurality of permanent magnets positioned around the rotor core in a circumferential direction of the rotor assembly and each including a planar outer contact surface, a planar inner contact surface, two axial end surfaces and two side surfaces, and a plurality of magnetic flux conductors. Magnetic flux conductors are provided to respective permanent magnets, the magnetic flux conductors each including a convex outer circumferential surface and a planar inner contact surface. The planar inner contact surface of the magnetic flux conductors are in contact with the planar outer contact surfaces of respective ones of the permanent magnets. The magnetic flux conductors are each defined by a single unitary structure made of an extruded material.

The production of the magnetic flux conductors can therefore be carried out particularly easily and economically. This simple geometry allows the magnetic flux conductors to be manufactured in an extrusion process.

The magnetic flux conductors are preferably in contact with the permanent magnets only via the flat inner contact surface. The convex outer circumferential surface and a flat inner contact surface of the magnetic flux conductor are preferably in direct contact with each other, which results in a particularly simple geometry of the magnetic flux conductor. The radius of convexity of the outer circumferential surface of the magnetic flux conductor is preferably smaller than or equal to the radius of the envelope of the rotor core, in particular at least half the radius of the envelope.

Between the circumferential surface and the contact surface there may be edges which are preferably deburred after extrusion. Extrusion is the process by which a strand is obtained. This workpiece is repeatedly cut to the height of a single magnetic flux conductor in the axial direction, so that a large number of magnetic flux conductors are obtained from one long strand. It can also be provided that the deburring takes place after cutting.

It is preferred that the magnetic flux conductors are made of soft steel with a high iron content, which is particularly easy to process.

Preferably, the rotor assembly includes a magnet holder which includes a plurality of holding sections, each of which is between two circumferentially adjacent permanent magnets and magnetic flux conductors and which are molded onto a base of the magnet holder, and which hold the magnetic flux conductors to the permanent magnets in the radial direction.

It is advantageous for the holding sections to include a shaft section and a head section, the shaft sections being T-shaped in a cross-section along a plane transverse to the central axis, so that the shaft sections fix the position of the permanent magnets and the magnetic flux conductors in the radial direction.

The magnetic holder is preferably injection-molded onto the rotor core.

The shaft sections preferably engage at least partially in axially extending grooves of the rotor core.

The head sections may engage in corresponding recesses of the rotor core, which are located in the area of the front surface of the rotor core, and thus define a position of the magnet holder in relation to the rotor core in the axial direction.

The rotor core is preferably made of a single unitary structure and manufactured in particular by cold pressing.

The permanent magnets are preferably cuboidal, which simplifies production considerably.

Preferred embodiments of the present disclosure are able to provide a brushless electric motor with a stator, a motor shaft rotatably mounted in a housing, and a rotor assembly mounted on the motor shaft with the features and advantages described above. Such an electric motor is easier to manufacture.

The above and other elements, features, steps, characteristics and advantages of the present disclosure will become more apparent from the following detailed description of the example embodiments with reference to the attached drawings.

### BRIEF DESCRIPTION OF THE DRAWINGS

Example preferred embodiments of the present disclosure are described in more detail below with reference to the drawings. Identical components or components with identical functions bear identical reference signs.

FIG. 1 illustrates a rotor assembly according to a preferred embodiment of the present invention in a top view in the direction of the center axis.

FIG. 2 is a perspective view of the rotor assembly from FIG. 1.

FIG. 3 is an electric motor with a rotor assembly according to a preferred embodiment of the present invention.

### DETAILED DESCRIPTION

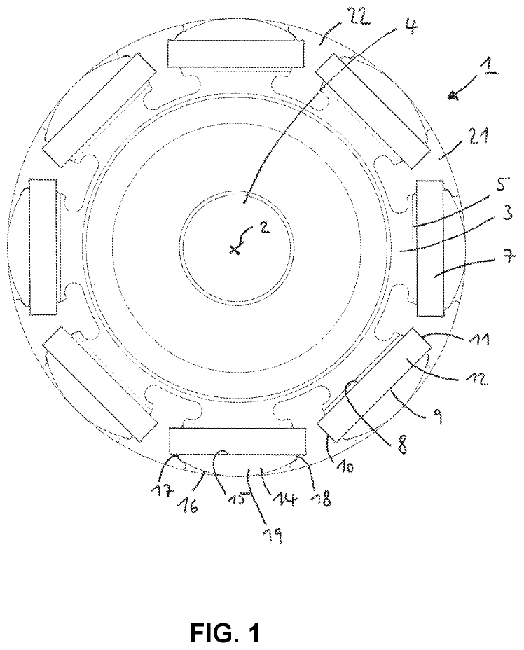

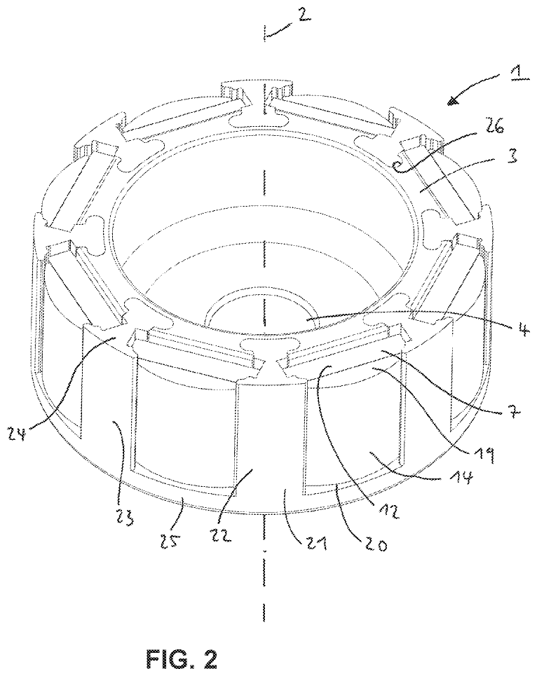

FIGS. 1 and 2 show a rotor assembly 1 with a central axis 2, which coincides with an intended axis of rotation of the rotor assembly 1. The rotor assembly 1 has a substantially rotationally symmetrical rotor core 3, which has a central bore 4 to accommodate a motor shaft not shown. The rotor core is an internal rotor core and part of a brushless electric motor designed as an internal rotor motor. On its outer surface, the rotor core has 3 flat outer surfaces 5. In this example embodiment, a total of eight outer surfaces 5, each of the same size and shape, are distributed at uniform angular intervals along the outer circumferential surface of the rotor core 3. The rotor core 3 is manufactured in one piece. It therefore does not consist of several lamellas lying on top of each other, or it is not available as a layered core. It is formed from one workpiece. It is preferably made of a soft steel with a high iron content and is preferably produced by cold pressing. Between each two outer surfaces 5 there is an unshown groove, which is formed from the outside in the radial direction into the edge formed by the two adjacent outer surfaces 5 in this area. The groove is open radially outwards and runs parallel to the central axis 2. A total of eight cuboid permanent magnets 7 rest against the outer surfaces 5, which magnets have a rectangular cross-section with an inner flat contact surface 8, an outer flat contact surface 9, and two flat side surfaces 10, 11. The inner contact surface 8 of the permanent magnets 7 points radially inwards towards the rotor core 3 and the outer contact surface 9 is opposite the inner contact surface and points radially outwards away from the rotor core 3. The side surfaces 10,11 extend in radial direction, perpendicular to the contact faces 8,9. Finally the permanent magnets 7 have axial end surfaces 12. The permanent magnets 7 are preferably made of neodymium or ferrite and are preferably manufactured in a sintering process.

Abutting the outer contact surfaces 9 of the permanent magnets there are magnetic flux conductors 14, each of the same size and shape, distributed at uniform angular intervals along the outer peripheral surface of the rotor core 3. The magnetic flux conductors 14 each have a flat contact surface 15, a convex outer circumferential surface 16 and side surfaces 17 and 18. The flat contact surface 15 of the magnetic flux conductors points radially inwards towards the rotor core 3 and the convex outer circumferential surface 16 points radially outwards away from the rotor core 3. The side surfaces 17 and 18 of the magnetic flux conductors extend approximately in radial direction and are opposite each other in circumferential direction. Finally, the magnetic flux conductors 14 still have axial end surfaces 19, 20. The magnetic flux conductors 14 lie with their flat contact surface 15 in contact with the outer contact surface 9 of the permanent magnets and extend over a range of at least 80% of the width of the outer contact surface in the circumferential direction. In axial direction the permanent magnets and the magnetic flux conductors preferably have the same length. The radius of convexity of the outer circumferential surface 16 of the magnetic flux conductor 14 is smaller than or equal to the radius of the envelope of the rotor core, in particular at least half the radius of the envelope. The magnetic flux conductors 14 are preferably made of a soft steel with a high iron content. The magnetic flux conductors 14 are preferably made in one piece, i.e. they do not consist of several lamellas lying on top of each other. They are manufactured from one workpiece, preferably in an extrusion process, and cut to their lengths extending in the axial direction. The side surfaces 17,18 of the magnetic flux conductors 14 are formed by deburring the edges. This makes the production of the magnetic flux conductors particularly easy.

The magnetic flux conductors are designed to influence the magnetic fluxes generated by the permanent magnets. Due to the convexity of the magnetic flux conductors, the magnetic flux is focused in such a way that a limited area with higher flux density is formed in a radial direction outwards, away from the rotor core.

The permanent magnets 7 and magnetic flux conductors 14 are held on the rotor core 3 by means of a magnet holder 21. The magnet holder 21 is preferably made of an injection-moldable plastic, preferably polybutylene terephthalate with 30% glass fiber (PBT 30) or polyamide (PA), and is preferably produced in an injection molding process. The magnetic holder 21 has holding sections 22, each of which has a shaft section 23 and a head section 24, whereby the shaft section 23 extends into the groove of the rotor core by means of a web and is held there with a positive fit. The shaft sections 23 of the holding sections 22 extend vertically from an annular base 25 of the magnet holder 21. The holding sections 22 are molded onto the outside of the base 25. The base 25 is dimensioned in such a way that the rotor core 3, the permanent magnets 7 and the magnetic flux conductors 14 rest with their one end surface at least partially on the base 25. The head section 24 is molded onto the side of the shaft section 23 remote from the base and extends in the radial direction of the arrangement, from the shaft section 23 in the direction of the rotor core 3. The permanent magnets 7 and the magnetic flux conductors 14 are fixed by the holding sections 22 in the circumferential direction of the rotor assembly 1 by resting with their side surfaces against the respective adjacent shaft section 23. The permanent magnets 7 and the magnetic flux conductors 14 are also held by the shaft sections 23 in the radial direction outwards. The shaft sections 23 have a seat for the permanent magnets 7 and a seat for the magnetic flux conductors 14. For this purpose, the shaft sections 23 are essentially T-shaped in cross-section, with the part extending in the radial direction engaging in the groove in the rotor core and the part extending in the circumferential direction holding the magnetic flux conductors 14 and the permanent magnets 7 in position in the radial direction. The head section 24 engages in a corresponding recess 26 of the rotor core 3, which is arranged in the area of the end surface of the rotor core 3 and thus forms a fixation of the magnet holder 21 relative to the rotor core 3 in the axial direction with the aid of the base 25 of the magnet holder 21. The head section 24 is further shaped in the radial direction in such a way that it engages in undercuts of the recess and thus additionally fixes the magnet holder 21 to the rotor core 3 in the radial direction. The permanent magnets 7 are pushed into the magnet holder 21 in the direction of the base 25. The shaft sections 23 serve as guides. The base 25 as a stop in axial direction. After the permanent magnets 7 have been inserted, the magnetic flux conductors 21 are pushed in in the same direction. Here too, the shaft sections 23 serve as a guide and the base 25 as a stop. Finally, a sleeve not shown is pushed onto the rotor assembly in the direction towards the base, covering the end surfaces of the elements 7,14,3 on the side facing away from the floor, thus fixing the position of the permanent magnets 7 and the magnetic flux conductors 14 in the axial direction with the help of the base 25 relative to the magnet holder 21.

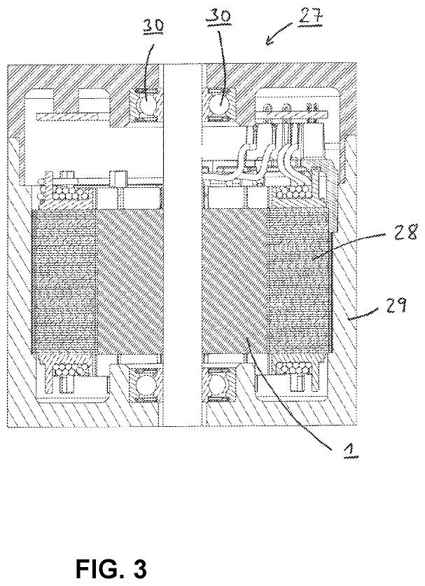

FIG. 3 shows a cross-sectional view of an electric motor 27 with the rotor assembly 1 according to the disclosure. The electric motor 27 comprises the stator 28. Inside the stator 28, the rotor assembly 1 is rotatably mounted in a manner known per se. The arrangement is surrounded by a motor housing 29, which carries roller bearings 30 for the rotatable mounting of rotor assembly 1.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-14. (canceled)

15. A rotor assembly of a brushless electric motor, the rotor assembly comprising:
an annular rotor core surrounding a central axis;
permanent magnets positioned around the rotor core in a circumferential direction of the rotor assembly, each of the permanent magnets including a planar outer contact surface, a planar inner contact surface, two axial end surfaces, and two side surfaces;
magnetic flux conductors provided in one-to-one correspondence to the permanent magnets, the magnetic flux conductors including a convex outer circumferential surface and a planar inner contact surface; wherein
the planar inner contact surfaces of respective ones of the magnetic flux conductors are in contact with the planar outer contact surfaces of corresponding ones of the permanent magnets; and
the magnetic flux conductors are defined by a single unitary structure made of an extruded material.

16. The rotor assembly according to claim 15, wherein the magnetic flux conductors are made of soft steel.

17. The rotor assembly according to claim 15, wherein the magnetic flux conductors are in contact with the permanent magnets only via the planar inner contact surface and the convex outer circumferential surface, and the planar inner contact surfaces of the magnetic flux conductors merge directly into one another and define a closed circumferential surface.

18. The rotor assembly according to claim 15, further comprising:
a magnet holder including a plurality of holding portions each between two circumferentially adjacent permanent magnets, and magnetic flux conductors which are on a bottom of the magnet holder; wherein
the magnet holder holds the magnetic flux conductors on the permanent magnets in a radial direction.

19. The rotor assembly according to claim 18, wherein
the holding portions each include a shaft portion and a head portion;
the shaft portions are T-shaped in a cross section along a plane extending transversely to the central axis so that the shaft portions fix a position of the permanent magnets and magnetic flux conductors in the radial direction.

20. The rotor assembly according to claim 18, wherein the magnet holder is made of an injection-molded material.

21. The rotor assembly according to claim 18, wherein the shaft sections are at least partially inserted into axially extending grooves of the rotor core.

22. The rotor assembly according to claim 18, wherein the head portions engage in corresponding recesses of the rotor core adjacent to an end surface of the rotor core and define a position of the magnet holder relative to the rotor core in the axial direction.

23. The rotor assembly according to claim 15, wherein the rotor core is defined by a single unitary structure.

24. The rotor assembly according to claim 23, wherein the rotor core is made of a cold-pressed material.

25. The rotor assembly according to claim 15, wherein the permanent magnets are cuboidal.

26. A brushless electric motor comprising:
a stator;
a motor shaft rotatably mounted in a housing; and
the rotor assembly according to claim 15 mounted on the motor shaft.

27. A method of producing a plurality of magnetic flux conductors of a rotor assembly of a brushless electric motor, including an annular rotor core surrounding a central axis, permanent magnets positioned around the rotor core in a circumferential direction of the rotor assembly, each of the permanent magnets including a planar outer contact surface, a planar inner contact surface, two axial end surfaces, and two side surfaces, and magnetic flux conductors corresponding to the permanent magnets, the magnetic flux conductors including a convex outer circumferential surface and a planar inner contact surface, the planar inner contact surfaces of respective ones of the magnetic flux conductors are in contact with the planar outer contact surfaces of corresponding ones of the permanent magnets, the method comprising the steps:
providing a die with an inner contour corresponding to the convex outer circumferential surface and the flat inner contact surface of the magnetic flux conductor;
inserting a pellet of soft steel into the die;
pressing the pellet with a punch through the die and creating a pressed strand with the contour of the magnetic flux conductor; and
cutting the press strand at predefined points to form a plurality of magnetic flux conductors of equal lengths.

28. A method of producing a rotor assembly of a brushless electric motor, including an annular rotor core surrounding a central axis, permanent magnets positioned around the rotor core in a circumferential direction of the rotor assembly and each including a planar outer contact surface, a planar inner contact surface, two axial end surfaces, and two side surfaces, magnetic flux conductors each of which corresponds to a respective one of the permanent magnets, wherein the magnetic flux conductors each include a convex outer circumferential surface and a planar inner contact surface, the planar inner contact surfaces of respective ones of the respective magnetic flux conductor abutting with the planar outer contact surfaces of corresponding ones of the permanent magnets, the method comprising:
providing a die with an inner contour corresponding to the convex outer circumferential surface and the flat inner contact surface of the magnetic flux conductor;
inserting a pellet of soft steel into the die;
pressing the pellet with a punch through the die and creating a pressed strand with the contour of the magnetic flux conductor; and
cutting the press strand at predefined points to form a plurality of magnetic flux conductors of equal or substantially equal lengths.
